(19) United States
(12) Patent Application Publication
(10) Pub. No.: US 2007/0061867 A1
(43) Pub. Date: Mar. 15, 2007

(54) Information processing apparatus, method and computer product for controlling activation of application

(75) Inventors: Makoto Shinohara, Kawasaki (JP); Kenichi Tsuboya, Kawasaki (JP); Hirofumi Endo, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/285,213

(22) Filed: Nov. 23, 2005

(30) Foreign Application Priority Data
Jul. 29, 2005 (JP) 2005-221655

(51) Int. Cl. H04L 9/32

(52) U.S. Cl. 726/2

(57) ABSTRACT

A storing unit stores determining data pertaining to permission of activation of an application. A control unit determines, when an activation request for an application is received, whether activation of the application is permitted based on the determining data, and activates the application when it is determined that the activation of the application is permitted.

### BACKGROUND OF THE INVENTION

1. Field of the Invention

The present invention relates to a technology for preventing a fraudulent activation of an application in an information processing apparatus.

2. Description of the Related Art

Recently, many mobile-phone terminals are equipped with a capability of downloading applications created in Java® script via a network and executing downloaded applications. By downloading desired applications, users can expand functions of the mobile-phone terminal for a variety of purposes.

Although the accessibility to diverse applications on the mobile-phone terminal enhances the users' convenience, prevention of a fraudulent operation becomes an extremely important issue. Generally, the users store personal data in the mobile-phone terminal, such as telephone numbers and mail addresses. Furthermore, a mobile-phone terminal having a location-data fetch function can fetch a current location of a user. If a fraudulent operation of the mobile-phone terminal is permitted to a malice, there is a possibility that the important personal data is misused.

A conventional technology to prevent a fraudulent operation of the mobile-phone terminal is disclosed in Japanese Patent Laid-Open Publication No. 2003-244065. According to the conventional technology, when an application is activated in the mobile-phone terminal from a server via the network, predetermined activation conditions are sent from the server to the mobile-phone terminal, so that the mobile-phone terminal can determine whether to activate the application based on the activation conditions.

Although the conventional technology can prevent a fraudulent use of applications via the network to some extent, a fraudulent use of an application by another application in the same mobile-phone terminal cannot be prevented.

Recently, a versatile operating system (OS) such as LINUX is installed in many mobile-phone terminals to reduce man-hours for enhancement of functions. In such mobile-phone terminals, an application can activate another application in the same mobile-phone terminal by specifying a path to a target application.

Therefore, if a downloaded application is of a malicious intent or infected with a virus, a fraudulent operation of another application can result in leakage of personal data or destruction of important data.

### SUMMARY OF THE INVENTION

It is an object of the present invention to at least solve the problems in the conventional technology.

An apparatus for executing an application, according to one aspect of the present invention, includes a storing unit that stores determining data pertaining to permission of activation of an application; a control unit that determines, when an activation request for an application is received, whether activation of the application is permitted based on the determining data, and activates the application when it is determined that the activation of the application is permitted.

A computer-readable recording medium according to another aspect of the present invention stores a computer program for controlling an activation of an application. The computer program causes a computer to execute controlling including determining, when an activation request for an application is received, whether activation of the application is permitted based on determining data pertaining to permission of activation of an application stored in a storing unit in advance; and activating the application when it is determined that the activation of the application is permitted.

A method of controlling an activation of an application, according to still another aspect of the present invention, includes controlling including determining, when an activation request for an application is received, whether activation of the application is permitted based on determining data pertaining to permission of activation of an application stored in a storing unit in advance; and activating the application when it is determined that the activation of the application is permitted.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic for illustrating a process in an application activating method according an embodiment of the present invention when there is an activation request from an application that is permitted to perform an activation of a target application;

FIG. 2 is a schematic for illustrating a process in the application activating method according to the present embodiment when there is an activation request from an application that is prohibited to perform an activation of a target application;

FIG. 3 is a schematic for illustrating a process in the application activating method according to the present embodiment when a target application is activated without an application-activation control unit;

FIG. 4 is a schematic for illustrating a process in the application activating method according to the present embodiment when there is an activation request from an unregistered application;

FIG. 5 is a schematic for illustrating a process in the application activating method according to the present embodiment when an activation of an unregistered application is refused at a confirmation of the activation;

FIG. 6 is a schematic for illustrating a process in the application activating method according to the present embodiment to make a confirmation of an activation of a target application to an external server when there is an activation request from an unregistered application;

FIG. 7 is a schematic for illustrating a process in the application activating method according to the present embodiment to make a confirmation of an activation of a target application to a settings file when there is an activation request from an unregistered application;

FIG. 8 is a block diagram of a mobile-phone terminal according to the present embodiment;

FIG. 9 is a schematic of an example of data configuration of an application-activation determining table;

FIG. 10 is a flowchart of a processing procedure performed by the mobile-phone terminal shown in FIG. 8;

FIG. 11 is a flowchart of a processing procedure performed by a target application; and

FIG. 12 is a block diagram of a computer that executes an application-activation control program.

### DETAILED DESCRIPTION OF THE PREFERRED EMBODIMENTS

Exemplary embodiments of the present invention are explained in detail below with reference to the accompanying drawings.

Although an explanation will be given for a mobile-phone terminal in which the versatile OS is installed, the present invention can also be applied to a mobile-phone terminal installed with any other OS. Moreover, the present invention can be applied to an information processing apparatus other than a mobile-phone terminal.

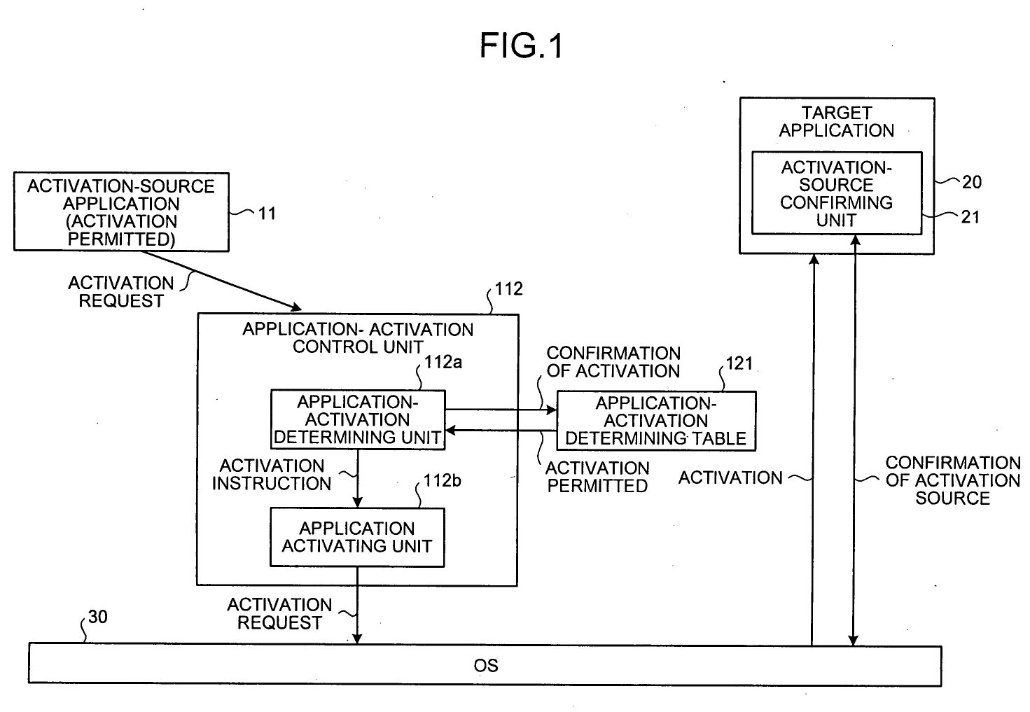

FIG. 1 is a schematic for illustrating a process in an application activating method according an embodiment of the present invention when there is an activation request from an application that is permitted to perform an activation of a target application.

In the application activating method according to the present embodiment, an activation-source application 11 activates a target application 20 via an application-activation control unit 112.

The application-activation control unit 112 includes an application-activation determining unit 112a and an application activating unit 112b. The application-activation determining unit 112a determines whether the activation-source application 11 has a permission to activate the target application 20 based on an application-activation determining table 121 to. If the application-activation determining unit 112a determines that the activation-source application 11 is permitted to activate the target application 20, the application activating unit 112b activates the target application 20.

A permission for the activation-source application 11 to activate the target application 20 is registered in the application-activation determining table 121. When there is a need to activate the target application 20, the activation-source application 11 requests the application-activation control unit 112 for an activation of the target application 20.

The application-activation control unit 112 is installed as a resident application or as a non-resident application. If the application-activation control unit 112 is installed as the resident application, the activation-source application 11 requests the application-activation control unit 112 that is currently running to activate the target application 20 by means of inter-process communication.

If the application-activation control unit 112 is installed as the non-resident application, the activation-source application 11 uses identification data of the target application 20 as an argument to activate the application-activation control unit 112 and requests an activation of application that is specified by the argument. The above activation request method is one example of activation request methods, and other activation request methods can also be used.

The application-activation determining unit 112a of the application-activation control unit 112, upon receiving the activation request, specifies the activation-source application 11 and the target application 20. For example, if the application-activation control unit 112 is installed as the resident application, the application-activation determining unit 112a specifies the activation-source application 11 from a handle of inter-process communication, and specifies the target application 20 from data transmitted during the inter-process communication.

If the application-activation control unit 112 is installed as the non-resident application, the application-activation determining unit 112a specifies the activation-source application 11 from parent process identification (ID), and specifies the target application 20 from data distributed by the argument. The above method is one example of specifying methods for the activation-source application 11 and the target application 20, and other specifying methods can also be used.

If the activation-source application 11 is specified as an activation source, and the target application 20 is specified as an activation target, the application-activation determining unit 112a refers to the application-activation determining table 121 to confirm whether the activation is permitted.

The application-activation determining unit 112a, upon confirming that a permission for the activation-source application 11 to activate the target application 20 is registered in the application-activation determining table 121, instructs the application activating unit 112b to activate the target application 20.

The application activating unit 112b, upon receiving the instruction to activate the target application 20, issues an activation request to an OS 30. The OS 30 activates the target application 20 in response to the activation request.

After activation, an activation-source confirming unit 21 of the target application 20 carries out activation source confirmation to specify the activation source that is responsible for activation of the target application 20. The activation source confirmation can be carried out, for example, by means of an inquiry to the OS 30 based on the parent process ID. The above method is one example of activation-source confirming methods, and other activation-source confirming methods can also be used.

When the activation-source confirming unit 21 specifies the application-activation control unit 112 as the activation source based on a result of the activation source confirmation, the target application 20 carries out a normal operation. Thus, when the activation-source application 11, which is permitted to activate the target application 20, activates the target application 20 via the application-activation control unit 112, the target application 20 functions normally.

In this manner, activating an application via the application-activation control unit 112 not only prevents fraudulent operation of the application, but also simplifies activation of the application. If an application is used to directly activate other applications, each application needs to recognize a path of the target application and activation options etc. However, in the application activating method according to the present embodiment, because the application-activation control unit 112 carries out the activation of applications, each application only needs to specify the target application.

Although not shown in FIG. 1, data related to the target application 20 such as a process ID can be notified to the activation-source application 11 with the aid of the application-activation control unit 112 after the target application 20 is activated to enable detailed control of the target application 20 by the activation-source application 11.

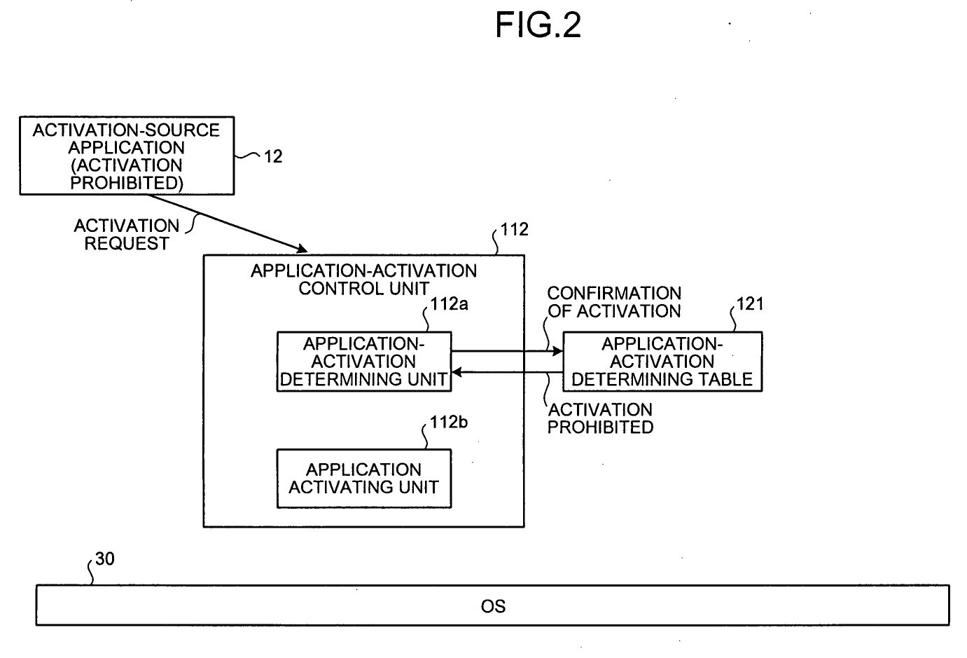

FIG. 2 is a schematic for illustrating a process in the application activating method according to the present embodiment when there is an activation request from an application that is prohibited to perform an activation of a target application.

Prohibition for an activation-source application 12 to activate the target application 20 is registered in the application-activation determining table 121. Assuming that the activation-source application 12 requests the application-activation control unit 112 to activate the target application 20, the application-activation determining unit 112a of the application-activation control unit 112, specifies the activation-source application 12 and the target application 20. If the activation-source application 12 is specified as the activation source, and the target application 20 is specified as the activation target, the application-activation determining unit 112a refers to the application-activation determining table 121 to confirm whether the activation is permitted.

The application-activation determining unit 112a, upon confirming that a prohibition for the activation-source application 12 to activate the target application 20 is registered in the application-activation determining table 121, ends the process without instructing the application activating unit 112b to activate the target application 20.

Thus, when the activation-source application 12 that is prohibited to carry out an activation tries to activate the target application 20 via the application-activation control unit 112, the target application 20 is not activated.

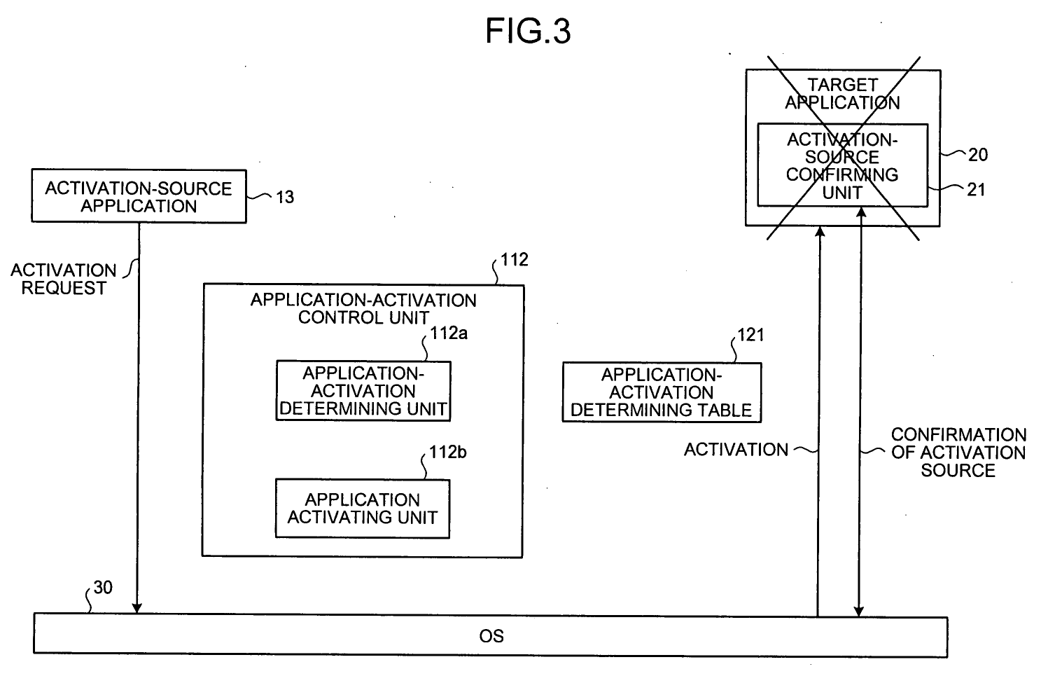

FIG. 3 is a schematic for illustrating a process in the application activating method according to the present embodiment when a target application is activated without the application-activation control unit 112.

An activation-source application 13 can be either one of an application that is permitted to activate the target application 20 and an application that is prohibited to activate the target application 20. The activation-source application 13 can also be an application for which permission or prohibition to activate the target application 20 is not registered in the application-activation determining table 121. The activation-source application 13 requests an activation of the target application 20 without using the application-activation control unit 112.

The OS 30, upon receiving the activation request, activates the target application 20 in response to the activation request. After activation, the activation-source confirming unit 21 of the target application 20 carries out activation source confirmation to specify the activation source that is responsible for activation of the target application 20.

When the activation-source confirming unit 21 specifies that the application-activation control unit 112 is not the activation source based on a result of activation source confirmation, the target application 20 forcibly terminates itself. Thus, when the activation-source application 13 activates the target application 20 without the aid of the application-activation control unit 112, the target application 20 does not function normally.

In the above application activating method, the activation-source confirming unit 21 needs to be provided for all the applications that need to be guarded against fraudulent activation to prohibit execution of an application without the application-activation control unit 112. A configuration that is explained next can be used when providing the activation-source confirming unit 21 is difficult.

First, when the application-activation control unit 112 activates an application in response to an activation request, data pertaining to the activated application is recorded as history. The application-activation control unit 112 periodically confirms activation status of applications, checks with the history, and if an application is activated without activation via the application-activation control unit 112, carries out a process to forcibly terminate the corresponding application.

Thus, providing a function to monitor fraudulent activation of applications in the application-activation control unit 112 removes the need to provide the activation-source confirming unit 21 for all the applications that need to be guarded against fraudulent activation. Moreover, when providing the function to monitor applications in the application-activation control unit 112, monitoring load can be reduced by prior selecting applications that are highly susceptible to leakage of data and monitoring only the selected applications.

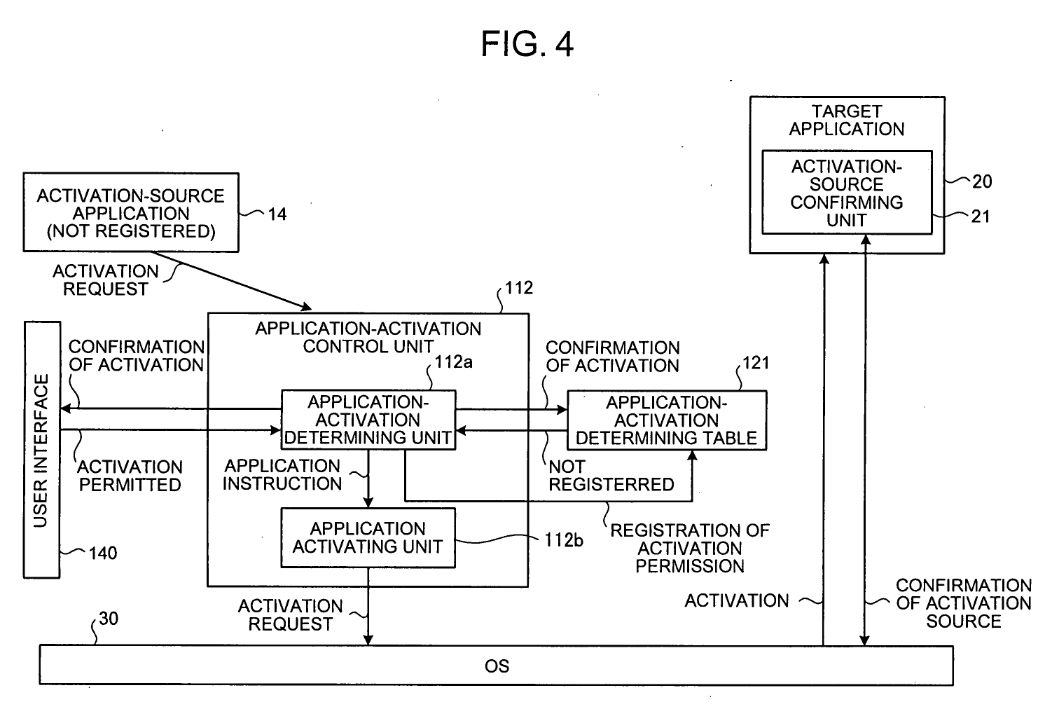

FIG. 4 is a schematic for illustrating a process in the application activating method according to the present embodiment when there is an activation request from an unregistered application.

Permission or prohibition for an activation-source application 14 to activate the target application 20 is not recorded in the application-activation determining table 121. Assuming that the activation-source application 14 requests the application-activation control unit 112 to activate the target application 20, the application-activation determining unit 112a of the application-activation control unit 112 specifies the activation-source application 14 and the target application 20. If the activation-source application 14 is specified as the activation source, and the target application 20 is specified as the activation target, the application-activation determining unit 112a refers to the application-activation determining table 121 to confirm whether an activation is permitted.

The application-activation determining unit 112a, upon confirming that permission for the activation-source application 14 to activate the target application 20 is not registered in the application-activation determining table 121, displays on a user interface 140 a notification pertaining to the activation-source application 14 trying to activate the target application 20 and seeks a confirmation of whether to permit the activation from the user.

If a permission to activate the target application 20 is confirmed, the application-activation determining unit 112a registers the permission for the activation-source application 14 to activate the target application 20 in the application-activation determining table 121 and instructs the application activating unit 112b to activate the target application 20.

The application activating unit 112b, upon receiving the instruction to activate the target application 20, issues an activation request to the OS 30. The OS 30 activates the target application 20 in response to the activation request.

After activation, the activation-source confirming unit 21 of the target application 20 carries out activation source confirmation to specify the activation source that is responsible for activation of the target application 20. When the activation-source confirming unit 21 specifies the application-activation control unit 112 as the activation source based on a result of activation source confirmation, the target application 20 carries out a normal operation.

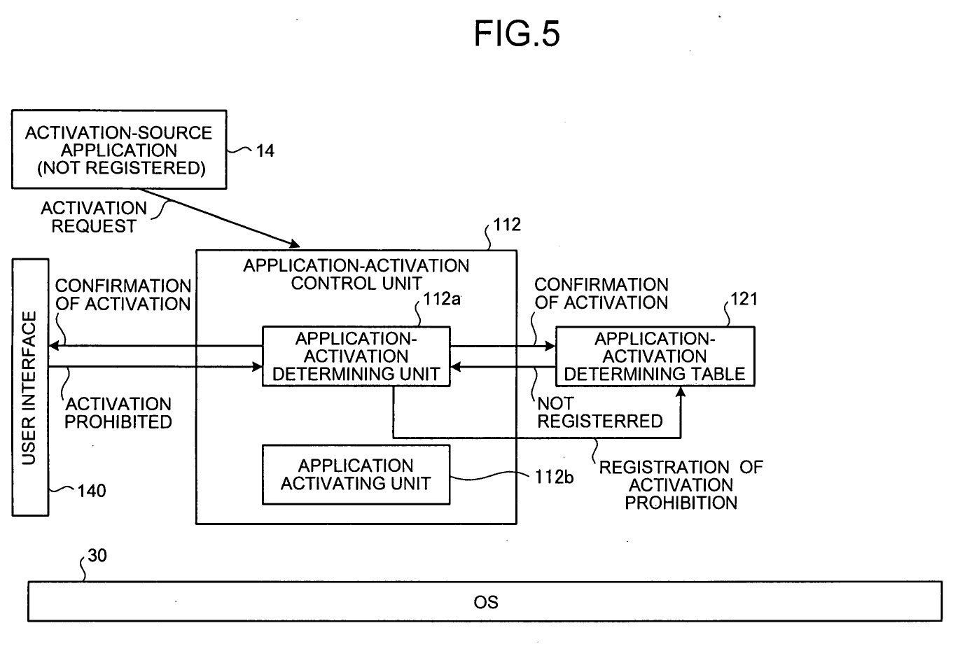

FIG. 5 is a schematic for illustrating a process in the application activating method according to the present embodiment when an activation of an unregistered application is refused at a confirmation of the activation.

The application-activation determining unit 112a of the application-activation control unit 112 displays on the user interface 140 a notification pertaining to the activation-source application 14 trying to activate the target application 20 and seeks a confirmation of whether to permit an activation from the user by means of the same process that is shown in FIG. 4.

If activation is prohibited, the application-activation determining unit 112a registers a prohibition for the activation-source application 14 to activate the target application 20 in the application-activation determining table 121 and terminates the process without instructing the application activating unit 112b to activate the target application 20.

Thus, when the activation-source application 14, for which permission or prohibition to activate the target application 20 is not registers tries to activate the target application 20, the application-activation determining unit 112a seeks a confirmation of whether to permit an activation from the user, and based on a result of the confirmation, determines whether to activate the target application 20. Moreover, the application-activation determining unit 112a registers the result of the confirmation from the user in the application-activation determining table 121, and uses the result to determine whether to permit activation for subsequent processes.

In the example shown in FIG. 5, if permission or prohibition to activate is not registered in the application-activation determining table 121, the application-activation determining unit 112a seeks a confirmation of whether to permit an activation from the user via the user interface 140. However, because the user may not always have sufficient knowledge pertaining to the applications, a result of confirmation by the user may not be always accurate.

To overcome this drawback, a reliable third person who has sufficient knowledge of applications prior recorded permission or prohibition of activation, and the recorded data can be referred if permission or prohibition of activation is not registered in the application-activation determining table 121.

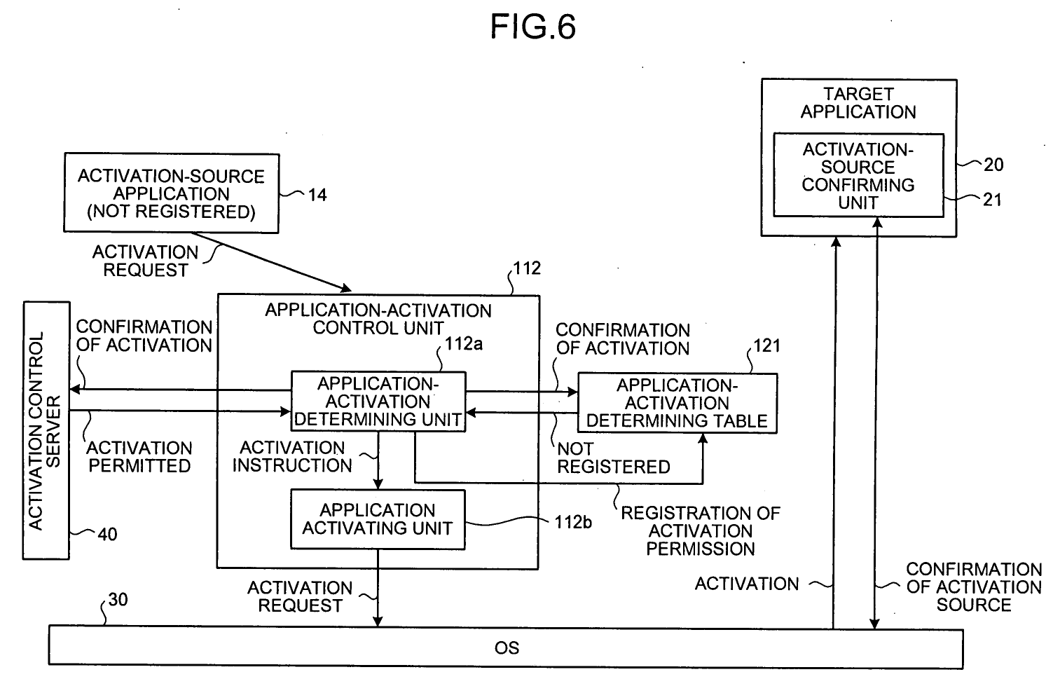

FIG. 6 is a schematic for illustrating a process in the application activating method according to the present embodiment to make a confirmation of an activation of a target application to an external server when there is an activation request from an unregistered application.

In the example shown in FIG. 6, a reliable third person having sufficient knowledge of applications registers permission or prohibition to activate the applications in an activation control server 40. If permission or prohibition of activation is not registered in the application-activation determining table 121, the application-activation determining unit 112a of the application-activation control unit 112 confirms whether an activation is permitted with the aid of the activation control server 40 via the network.

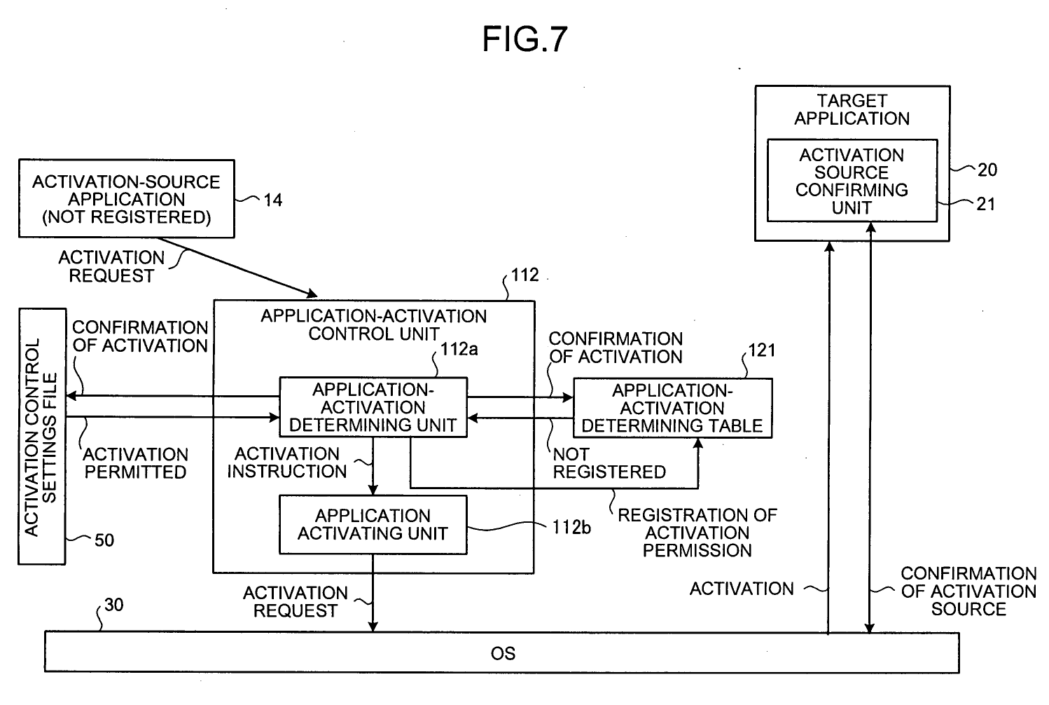

FIG. 7 is a schematic for illustrating a process in the application activating method according to the present embodiment to make a confirmation of an activation of a target application to a settings file when there is an activation request from an unregistered application.

In the example shown in FIG. 7, a reliable third person having sufficient knowledge of applications registers permission or prohibition to activate the applications in an activation-control settings file 50. The activation-control settings file 50 is downloaded together with the activation-source application 14 to the mobile-phone terminal and stored in the mobile-phone terminal.

If permission or prohibition of activation is not registered in the application-activation determining table 121, the application-activation determining unit 112a of the application-activation control unit 112 confirms whether an activation is permitted with the aid of the activation-control settings file 50.

Methods that are shown in FIGS. 5 to 7 to confirm whether an activation is permitted can be combined and applied in an order of priority when there is an activation request from an unregistered application. Because prior registration of permission or prohibition of activation for all the applications in the activation control server 40 and the activation-control settings file 50 is difficult, data that is prior registered as shown in FIGS. 6 and 7 can be confirmed first, and if permission or prohibition of activation is not registered, a confirmation can be sought from the user as shown in FIG. 5, thereby enabling a useful combination of the aforementioned methods to confirm whether an activation is permitted.

Methods other than the above methods to confirm whether an activation is permitted can also be applied separately or in combination.

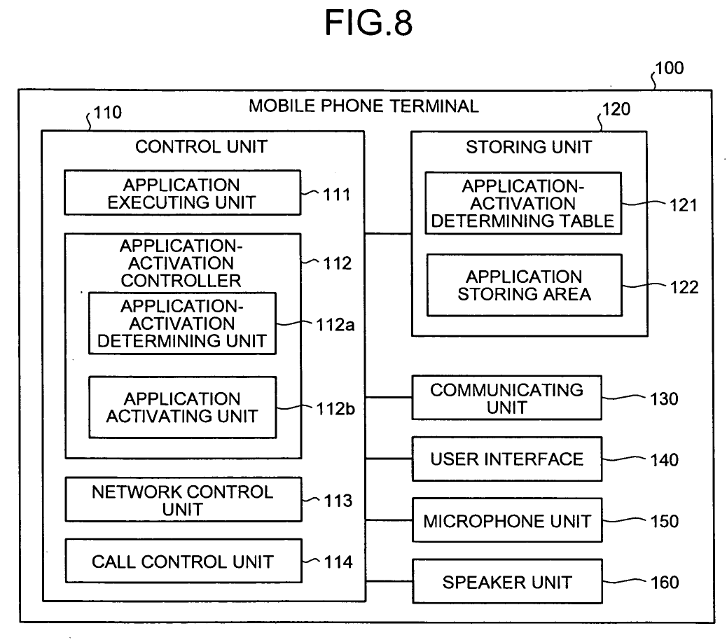

FIG. 8 is a block diagram of a mobile-phone terminal 100 according to the present embodiment. The mobile-phone terminal 100 includes a control unit 110, a storing unit 120, a communicating unit 130, the user interface 140, a microphone unit 150, and a speaker unit 160.

The control unit 110 controls the entire mobile-phone terminal 100 and includes an application executing unit 111, the application-activation control unit 112, a network control unit 113, and a call control unit 114.

The application executing unit 111 executes applications that are originally installed in the mobile-phone terminal 100 and applications that are added by downloading.

The application-activation control unit 112 receives an activation requests from an application for activation of another application. The application-activation control unit 112 includes the application-activation determining unit 112a and the application activating unit 112b. The application-activation control unit 112, upon receiving the activation request, confirms whether an activation of the target application is permitted, and activates the target application in response to the activation request only upon receiving the confirmation to activate the target application.

The application-activation determining unit 112a determines whether the activation-source application is permitted to activate the target application. The application-activation determining unit 112a refers the application-activation determining table 121 of the storing unit 120 to confirm whether permission or prohibition to activate the target application is registered in the application-activation determining table 121. If permission or prohibition to activate the target application is registered in the application-activation determining table 121, the application-activation determining unit 112a performs a process based on registered content.

If permission or prohibition to activate the target application is not registered in the application-activation determining table 121, the application-activation determining unit 112a displays an activation-permission-confirmation screen on the user interface 140, carries out a process to seek confirmation of whether an activation is permitted from the user, and registers a result of the confirmation in the application-activation determining table 121.

The application activating unit 112b carries out activation of the target application if the application-activation determining unit 112a determines that activation of the target application is permitted.

The network control unit 113 controls a communication that is carried out via the network. The network control unit 113 controls a variety of functions, such as sending and receiving of e-mails, browsing of web pages, and downloading of files and applications. The call control unit 114 controls a telephone call, such as a sound call and a video-phone call.

The storing unit 120 stores various types of data and applications, and includes the application-activation determining table 121 and an application storing area 122. The storing unit 120 can include physically different multiple recording media consisting of a nonvolatile memory such as a read only memory (ROM), a flash memory, or a detachable memory card. The application-activation determining table 121 and the application storing area 122 can be stored separately in multiple recording media.

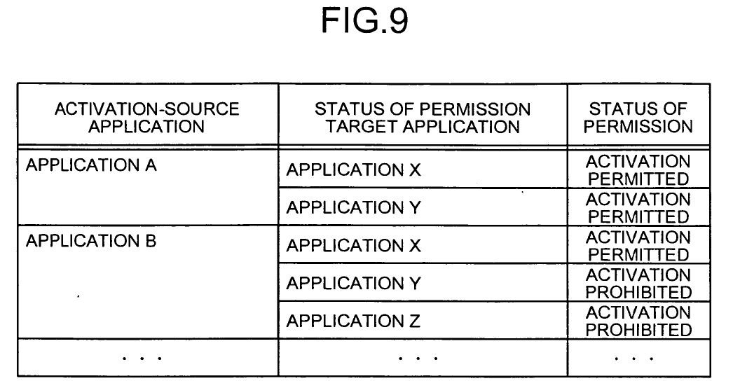

FIG. 9 is a schematic of an example of data configuration of the application-activation determining table 121. Permission or prohibition of activation can be registered for each pair of the activation-source application and the target application. The permission or prohibition of activation can also be recorded in another format.

Applications that are originally installed in the mobile-phone terminal 100 and applications that are added by downloading are stored in the application storing area 122.

The communicating unit 130 carries out a wireless communication for network communication and a telephone call. The user interface 140 includes a display on which data for the user is displayed and an input unit that receives an operation from the user. The microphone unit 150 and the speaker unit 160 act as a microphone and a speaker respectively during a call.

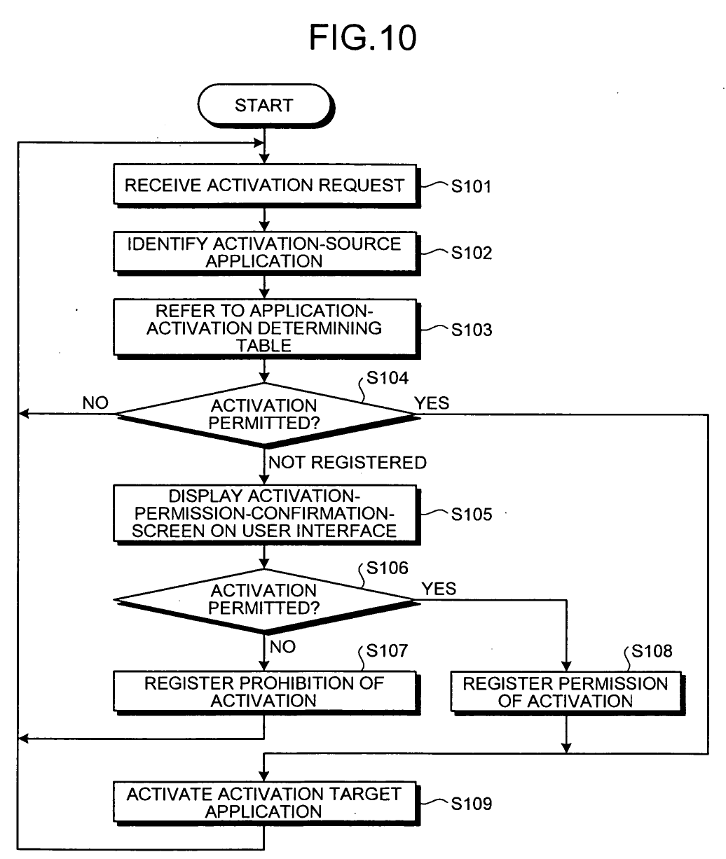

FIG. 10 is a flowchart of a processing procedure performed by the mobile-phone terminal 100 shown in FIG. 8. In the example shown in FIG. 10, confirmation of activation is sought from the user if permission or prohibition of activation is not registered in the application-activation determining table 121.

The application-activation control unit 112 of the mobile-phone terminal 100, upon receiving an activation request for an application (step S101) identifies the activation-source application (step S102) and refers to the application-activation determining table 121 (step S103) to confirm whether the activation-source application is permitted to activate the target application.

If prohibition of activation is registered in the application-activation determining table 121 (“NO” at step S104), the application-activation control unit 112 does not activate the target application, the process returns to step S101, and a process for the next activation request is carried out. If permission of activation is registered in the application-activation determining table 121 (“YES” at step S104), the application-activation control unit 112 activates the target application (step S109), the process returns to step S101 and the application-activation control unit 112 carries out a process for the next activation request.

If permission or prohibition of activation is not registered in the application-activation determining table 121 (“NOT REGISTERED” at step S104), the application-activation control unit 112 displays on the user interface 140 a screen to confirm whether an activation is permitted (step S105). If activation is not permitted (“NO” at step S106), the application-activation control unit 112 registers prohibition of activation in the application-activation determining table 121 (step S107) and does not activate the target application. The process returns to step S101 and to carry out a process for the next activation request.

If activation is permitted by the user (“YES” at step S106), the application-activation control unit 112 registers permission of activation in the application-activation determining table 121 (step S108), and activates the target application (step S109). Then, the process returns to step S101 to carry out a process for the next activation request.

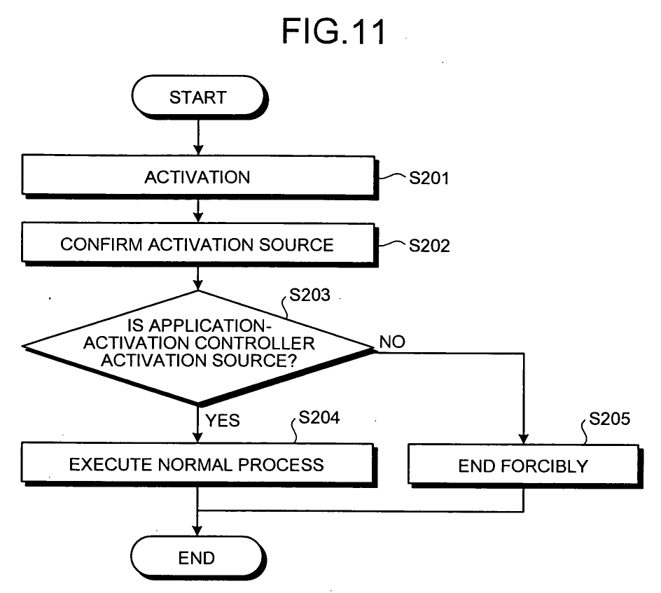

FIG. 11 is a flowchart of a processing procedure performed by a target application. The target application indicates an application that is activated by an activation-source application. The sequence of the process shown in FIG. 11 is pertaining to the target application that needs to be guarded against fraudulent activation.

Target application, upon getting activated (step S201) confirms an activation source (step S202). If the application-activation control unit 112 is the activation source (“YES” at step S203), the target application executes a normal process (step S204). If the application-activation control unit 112 is not the activation source (“NO” at step S203), the target application forcibly terminates (step S205).

Each process of the application-activation control unit 112 explained in the present embodiment can be implemented by means of executing an application-activation control program.

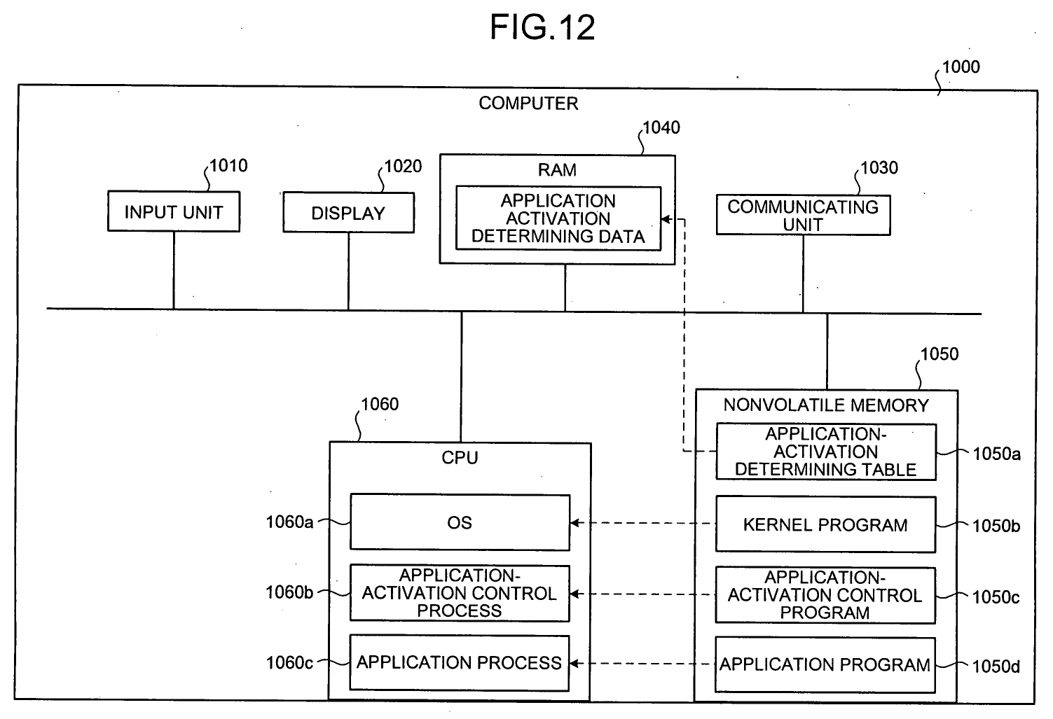

FIG. 12 is a block diagram of a computer 1000 that executes the application-activation control program. The computer 1000 includes an input unit 1010 that receives input of data from the user, a display 1020, a communicating unit 1030 that carries out various types of communication, a random access memory (RAM) 1040 that temporarily stores various types of data, a nonvolatile memory 1050, and a central processing unit (CPU) 1060.

An application-activation control program 1050c, which fulfils functions similar to the functions of the application-activation control unit 112, is stored in the nonvolatile memory 1050. A kernel program 1050b, an application program 1050d, and an application-activation determining table 1050a that corresponds to the application-activation determining table 121 are also stored in the nonvolatile memory 1050.

For sake of convenience, although only a single application program is shown as stored in the nonvolatile memory 1050 shown in FIG. 12, multiple application programs can be stored in the nonvolatile memory 1050.

The kernel program 1050b is read by the CPU 1060 from the nonvolatile memory 1050 and executed, thereby enabling the kernel program 1050b to function as an OS 1060a. The OS 1060a corresponds to the application executing unit 111.

Based on a request from the OS 1060a, the application-activation control program 1050c is read by the CPU 1060 from the nonvolatile memory 1050 and executed, thereby enabling the application-activation control program 1050c to function as an application-activation control process 1060b. The application-activation control process 1060b corresponds to the application-activation control unit 112.

Based on a request from the application-activation control process 1060b, the application program 1050d is read by the CPU 1060 from the nonvolatile memory 1050 and executed, thereby enabling the application program 1050d to function as an application process 1060c.

The CPU 1060 reads necessary data from the application-activation determining table 1050a of the nonvolatile memory 1050 and stores the read data in the RAM 1040 as application-activation determining data 1040a. The CPU 1060 executes various types of data processes based on the application-activation determining data 1040a stored in the RAM 1040.

The application-activation control program 1050c need not always be stored in the nonvolatile memory 1050. The application-activation control program 1050c can be stored in any other type of computer-readable storage medium. The application-activation control program 1050c can be stored in, for example, a memory card. The application-activation control program 1050c can also be stored in other computer or server that is connected to the computer 1000 via a network. The network can be a wired network or a wireless network.

According to the present embodiment, the application-activation control unit 112 determines whether an activation is permitted based on determining data, which is stored beforehand, and activates the application only after determining that activation is permitted, thereby enabling to prevent fraudulent activation of an application in the same device.

Furthermore, according to the present embodiment, after activation of an application, the activated application confirms the activation source and terminates the process if the application-activation control unit 112 is not the activation source, thereby enabling to prevent a fraudulent activation of an application without the application-activation control unit 112.

According to the present invention, it is possible to prevent a fraudulent activation of an application.

Furthermore, according to the present invention, it is possible to prevent a fraudulent activation of an application without an aid of an activation control unit.

Moreover, according to the present invention, a fraudulent activation of an application can be prevented even if information pertaining to the application is not registered beforehand.

Furthermore, according to the present invention, a user's determination whether to permit an activation can be used to determine whether to permit the activation of an application if an activation request for the same application is received.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An apparatus for executing an application, the apparatus comprising:
a storing unit that stores determining data pertaining to permission of activation of an application;
a control unit that determines, when an activation request for an application is received, whether activation of the application is permitted based on the determining data, and activates the application when it is determined that the activation of the application is permitted.

2. The apparatus according to claim 1, further comprising:
a terminating unit that terminates activated application when an activation source of the application is not the control unit.

3. The apparatus according to claim 1, wherein
when determining data corresponding to the application for which the activation request is received is not stored in the storing unit, the control unit displays a screen for confirming a permission of activation, and determines whether the activation of the application is permitted based on a response to the screen.

4. The apparatus according to claim 3, wherein
the control unit stores a result of determination that is made based on the response to the screen in the storing unit.

5. The apparatus according to claim 1, wherein
when determining data corresponding to the application for which the activation request is received is not stored in the storing unit, the control unit performs an inquiry to a server that stores the determining data, and determines whether the activation of the application is permitted based on a response to the inquiry.

6. The apparatus according to claim 5, wherein
the control unit stores a result of determination that is made based on the response to the inquiry in the storing unit.

7. The apparatus according to claim 1, wherein
settings data in which the determining data is set is provided for each request source, and
when determining data corresponding to the application for which the activation request is received is not stored in the storing unit, the control unit determines whether the activation of the application is permitted based on the settings data.

8. The apparatus according to claim 7, wherein
the control unit stores a result of determination that is made based on the settings data in the storing unit.

9. A computer-readable recording medium that stores a computer program for controlling an activation of an application, wherein the computer program causes a computer to execute:
controlling including
determining, when an activation request for an application is received, whether activation of the application is permitted based on determining data pertaining to permission of activation of an application stored in a storing unit in advance; and
activating the application when it is determined that the activation of the application is permitted.

10. The computer-readable recording medium according to claim 9, wherein
the computer program further causes the computer to execute
terminating activated application when an activation source of the application is not the control unit.

11. The computer-readable recording medium according to claim 9, wherein
when determining data corresponding to the application for which the activation request is received is not stored in the storing unit, the determining includes
displaying a screen for confirming a permission of activation; and
determining whether the activation of the application is permitted based on a response to the screen.

12. The computer-readable recording medium according to claim 9, wherein
when determining data corresponding to the application for which the activation request is received is not stored in the storing unit, the determining includes
performing an inquiry to a server that stores the determining data; and
determining whether the activation of the application is permitted based on a response to the inquiry.

13. The computer-readable recording medium according to claim 9, wherein
settings data in which the determining data is set is provided for each request source, and
when determining data corresponding to the application for which the activation request is received is not stored in the storing unit, the determining includes determining whether the activation of the application is permitted based on the settings data.

14. A method of controlling an activation of an application, the method comprising:
controlling including
determining, when an activation request for an application is received, whether activation of the application is permitted based on determining data pertaining to permission of activation of an application stored in a storing unit in advance; and
activating the application when it is determined that the activation of the application is permitted.

15. The method according to claim 14, further comprising:
terminating activated application when an activation source of the application is not the control unit.

16. The method according to claim 14, wherein
when determining data corresponding to the application for which the activation request is received is not stored in the storing unit, the determining includes
displaying a screen for confirming a permission of activation; and
determining whether the activation of the application is permitted based on a response to the screen.

17. The method according to claim 14, wherein
when determining data corresponding to the application for which the activation request is received is not stored in the storing unit, the determining includes
performing an inquiry to a server that stores the determining data; and
determining whether the activation of the application is permitted based on a response to the inquiry.

18. The method according to claim 14, wherein
settings data in which the determining data is set is provided for each request source, and
when determining data corresponding to the application for which the activation request is received is not stored in the storing unit, the determining includes determining whether the activation of the application is permitted based on the settings data.
